(19) United States
(12) Patent Application Publication
(10) Pub. No.: US 2011/0007507 A1
(43) Pub. Date: Jan. 13, 2011

(54) ILLUMINATED WIRE-FRAME FORM

(76) Inventor: Matthew P. Braasch, Chicago, IL (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 12/831,549

(22) Filed: Jul. 7, 2010

Related U.S. Application Data
(60) Provisional application No. 61/223,601, filed on Jul. 7, 2009.

(51) Int. Cl. F21S 4/00

(52) U.S. Cl. 362/249.1; 362/249.01; 362/249.14

(57) ABSTRACT

An illuminated wire-frame form has adjustable joints that permit customizing the form into one of a plurality of different configurations or poses. In addition, interchangeable accessories with a quick-connect fitting for the light elements can be provided.

### RELATED APPLICATIONS

This application claims the benefit of U.S. Provisional Patent Application No. 61/223,601 filed Jul. 7, 2009, the entire content of which is incorporated by reference herein.

### BACKGROUND

The present invention relates to illuminated wire-frame forms.

Illuminated wire-frame deer and other seasonal figures have become one of the most popular categories in outdoor decorating for Christmas and other holidays (e.g., Halloween). As an example, one of the most popular styles are sculptures of deer in various poses. Some of the most popular poses of deer are a standing deer, a lying or kneeling deer, a prancing deer, and a leaping deer. Retailers must decide which, if not all, of the styles to carry as part of their merchandise mix. These choices are further compounded by the options of buck or doe deer. Other figures or forms (e.g., Santa, snowmen, elves, sleighs, moose, horses, and Halloween figures) are also known and can have a variety of different fixed forms.

All of these options cause retailers to carry multiple styles that confuse consumers and take up additional amounts of valuable display space in the stores. If the retailer does not make a correct choice about the styles selected and the number of each style purchased, the result is unnecessary inventory and exposure to excessive seasonal markdowns.

### SUMMARY

The invention provides an illuminated wire-frame form having adjustable joints that permit customizing the form into one of a plurality of different configurations or poses. For example, a deer form can have legs with adjustable joints at strategic areas of the leg (e.g., the hip and/or knee joints) such that one or more of the legs can be configured by the user as desired. Additionally, the neck, head, and perhaps even the tail can have adjustable joints that permit rotation and/or pivoting to a desired configuration. In addition, the antlers and any other features can be interchangeable, with a quick-connect fitting for the light elements. This allows the retailer or user to select one or more buck antler formations, or to make the deer a doe. The adjustable joint and quick-connect features can be used on any wire-frame form, and are not limited to deer forms.

In another embodiment the invention provides a method of providing a re-configurable wire-frame form, in which a retailer and/or a user can adjust and customize the configuration or pose of a base wire-frame form to one of a plurality of available configurations or poses.

More specifically, the invention provides a wire-frame form including a first member, a second member coupled to the first member with an adjustable joint such that the first and second members can be positioned relative to one another in one of a plurality of different stationary display configurations, and light elements positioned on each of the first and second members. The light elements are operable when the first and second members are in any one of the plurality of different stationary display configurations to illuminate the first and second members.

In one aspect of the invention, the wire-frame form further includes a support stand coupled to one of the first and second members adjacent the adjustable joint. The support stand is movable between a first position for supporting the wire-frame form in one of the plurality of different stationary display configurations, and a second position that does not support the wire-frame form.

The invention further provides an illuminated, wire-frame deer including a body, a head coupled to the body, and four legs coupled to the body. Each of the four legs has an adjustable joint enabling the leg to be configured into a plurality of fixed orientations such that the wire-frame deer can be selectively oriented into any one of a standing pose, a prancing pose, a leaping pose, and a kneeling pose. Light elements are positioned on each of the body, the head, and the legs.

Other aspects of the invention will become apparent by consideration of the detailed description and accompanying drawings.

### BRIEF DESCRIPTION OF THE DRAWINGS

FIG. 1 is a perspective view of an illuminated deer wire-frame form embodying the present invention shown in a first, straight-leg standing configuration.

FIG. 2 is a perspective view of the illuminated deer wire-frame form of FIG. 1 shown in a second, bent-knee or prancing configuration.

FIG. 3 is a perspective view of the illuminated deer wire-frame form of FIG. 1 shown in a third, bent-knee and extended leg flying/leaping configuration.

FIG. 3a is an enlarged partial view of the deer wire-frame form of FIG. 3 showing a coupling of a support member.

FIG. 4 is a perspective view of the illuminated deer wire-frame form of FIG. 1 shown in a fourth, bent-knee kneeling or lying configuration.

FIG. 5 is an enlarged partial perspective view of an adjustable joint configuration of a first embodiment of the invention, shown with the light elements removed for clarity.

FIG. 6 is an exploded view of the adjustable joint configuration of FIG. 5.

FIG. 7 is an enlarged partial perspective view of an adjustable joint configuration of a second embodiment of the invention, shown with the light elements removed for clarity.

FIG. 8 is an exploded view of the adjustable joint configuration of FIG. 7.

FIG. 9 is an enlarged partial perspective view of an adjustable joint configuration of a third embodiment of the invention, shown with the light elements removed for clarity.

FIG. 10 is an exploded view of the adjustable joint configuration of FIG. 9.

FIG. 11 is an enlarged perspective view of an accessory member having a quick-connect electrical connection.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

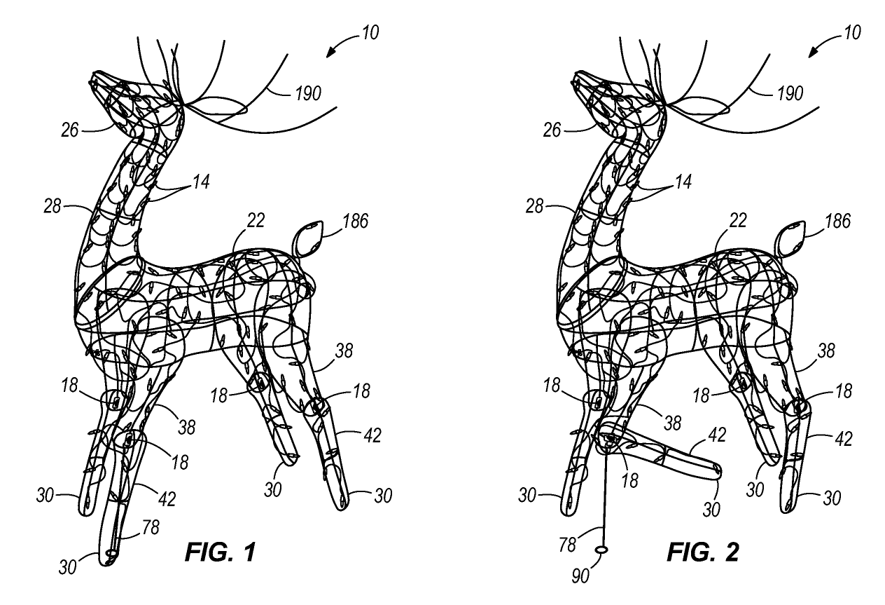

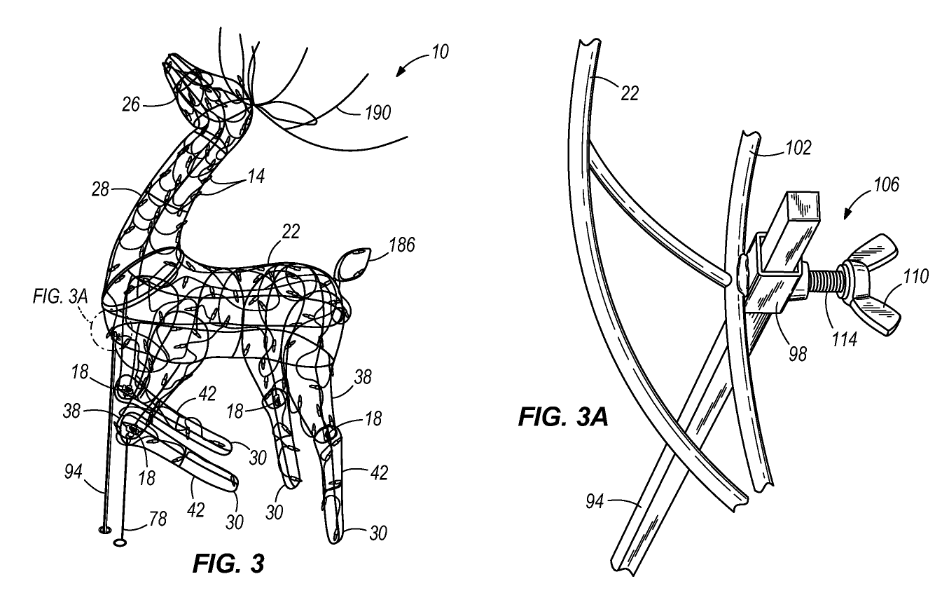

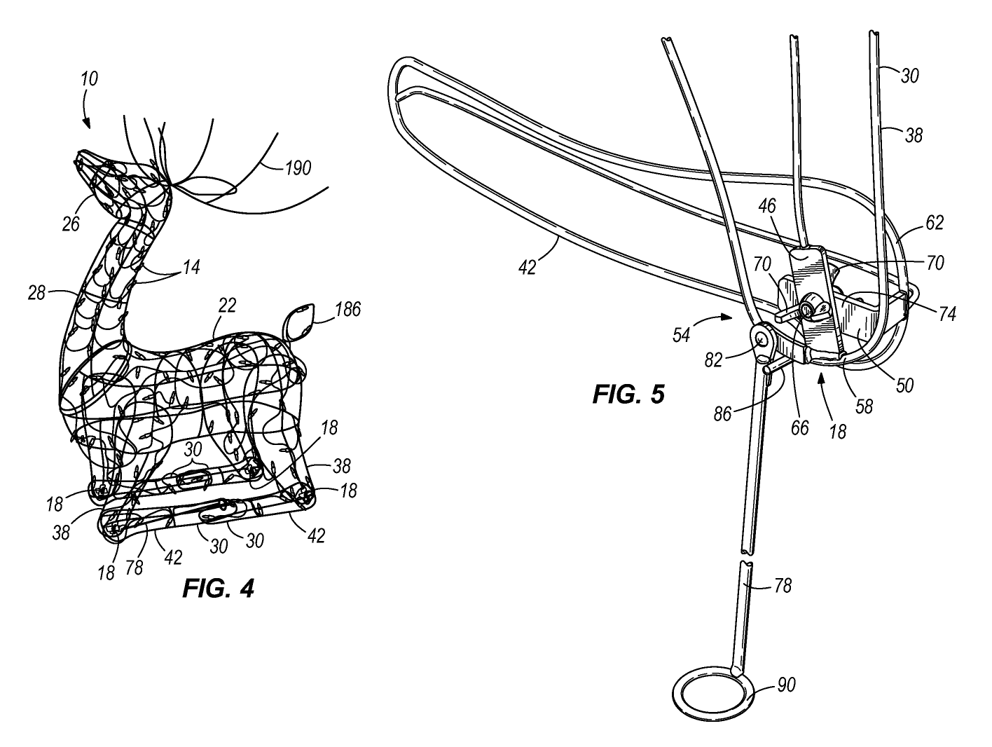

The invention can be applied to any wire-frame form (e.g., Santa, snowmen, elves, sleighs, moose, horses, and Halloween figures), and in the illustrated embodiment is shown with respect to an illuminated deer form 10 having light elements 14 (e.g., light strings with bulbs, LED's, fiber optic strands, etc.) positioned thereon. Adjustable joints 18 can be provided at the hip or knee joints of the legs to configure or pose the legs in a straight standing configuration (FIG. 1), a bent knee or prancing configuration (FIG. 2), a bent knee and extended leg flying/leaping configuration (FIG. 3), or a kneeling or lying configuration (FIG. 4). Other display configurations or poses (to be distinguished from storage positions in which the form is not being displayed) that are not shown can also be achieved.

Referring now to FIGS. 1-4, the wire-frame deer 10 includes a body 22, a head 26 and a neck 28 coupled to the body 22, and four legs 30 coupled to the body 22. The body 22, head 26, neck 28, and legs 30 can be formed of wire (e.g., metal wire) to define the frame of the deer 10. The light elements 14 can be coupled to the entire wire frame of the deer 10 (i.e., to the body 22, the head 26, the neck 28 and each of the legs 30) using conventional methods. In some embodiments, a webbing material (not shown) can be provided on the wire frame of the deer 10 to provide a more three-dimensional shape or covering to the deer 10. The webbing material can be any suitable material, including plastic bands or cords wrapped over and around the individual wires making up the wire frame of the deer 10. Light reflecting elements, such as sequins or other reflective materials can be included with the webbing material to reflect and enhance the light given off by the light elements 14.

Each leg 30 is formed by a first member 38 (e.g., the upper leg) and a second member 42 (e.g., the lower leg) coupled together with the adjustable joint 18 such that the first and second members 38, 42 can be positioned relative to one another in one of a plurality of different stationary display configurations or poses (see FIGS. 1, 2, 3, and 4). Light elements 14 positioned on each of the first and second members 38, 42 are not disrupted by the adjustment of the first and second members 38, 42 between different display configurations, and are therefore operable to illuminate the first and second members 38, 42 in any of the display configurations shown in the figures.

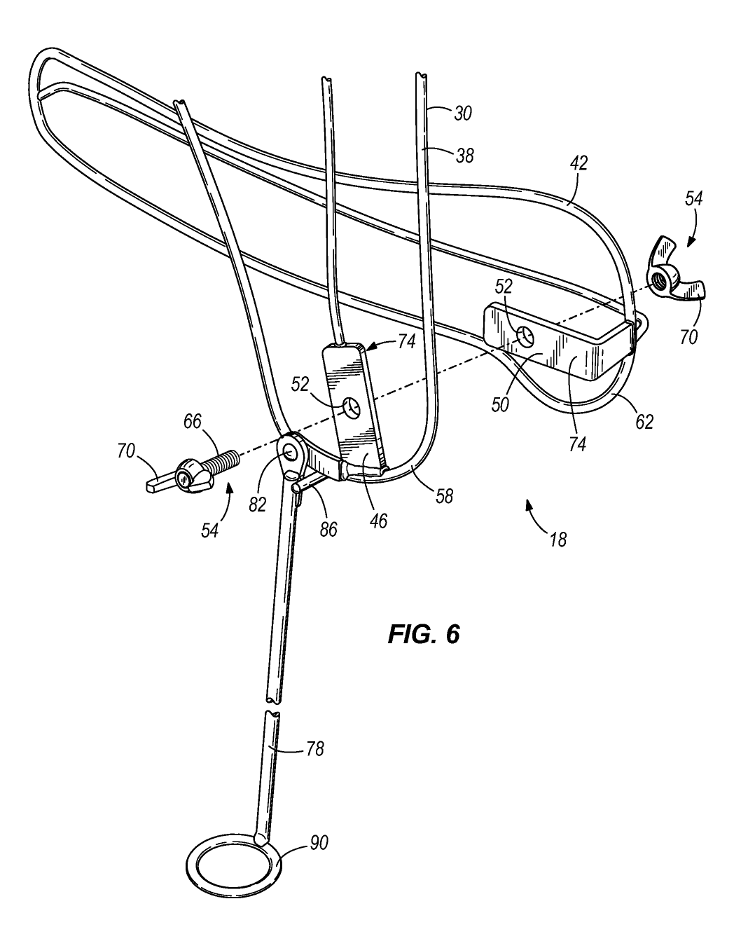

FIGS. 5 and 6 illustrate a first embodiment of the joint 18 that is used on each of the four legs 30. The joint 18 includes a first plate element 46 on the first member 38, a second plate element 50 on the second member 42, and a fastener arrangement 54 releasably securing the first plate element 46 relative to the second plate element 50. The first plate element 46 is secured (e.g., by welding) to a wire 58 of the first member 38 and the second plate element 50 is secured (e.g., by welding) to a wire 62 of the second member 42. Each plate element 46, 50 includes an aperture 52 (see FIG. 6) for receiving a portion of the fastener arrangement 54 therethrough. While the illustrated plate elements 46, 50 are made of metal and are generally rectangular in shape, the plate elements 46, 50 can alternatively be made of plastic or other materials, can be secured to the respective wires 58 and 62 in other suitable manners, and can take various other shapes.

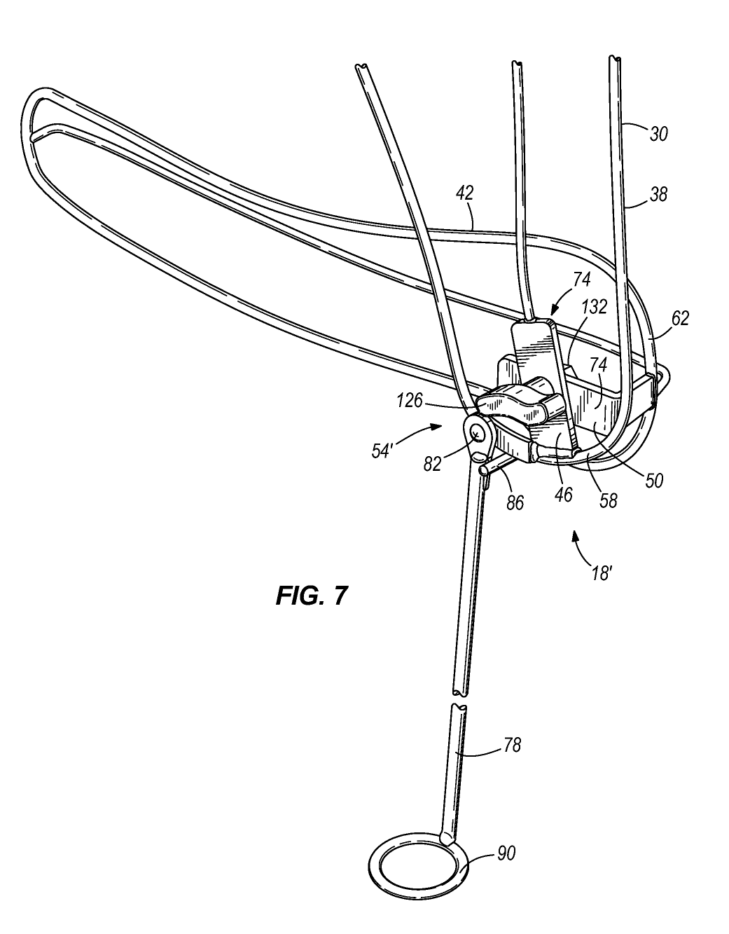

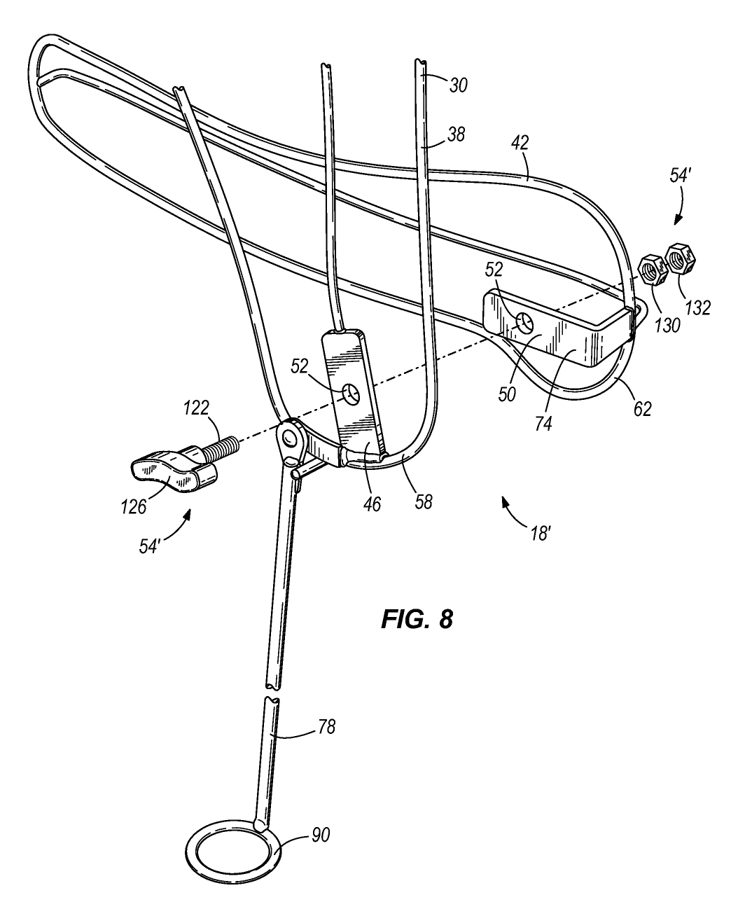

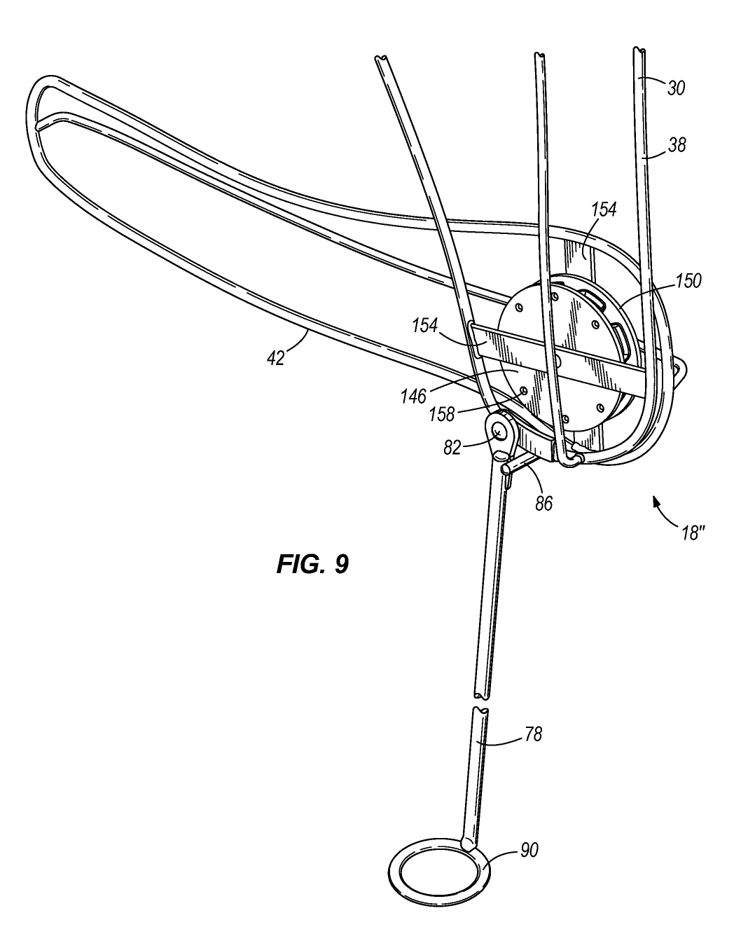

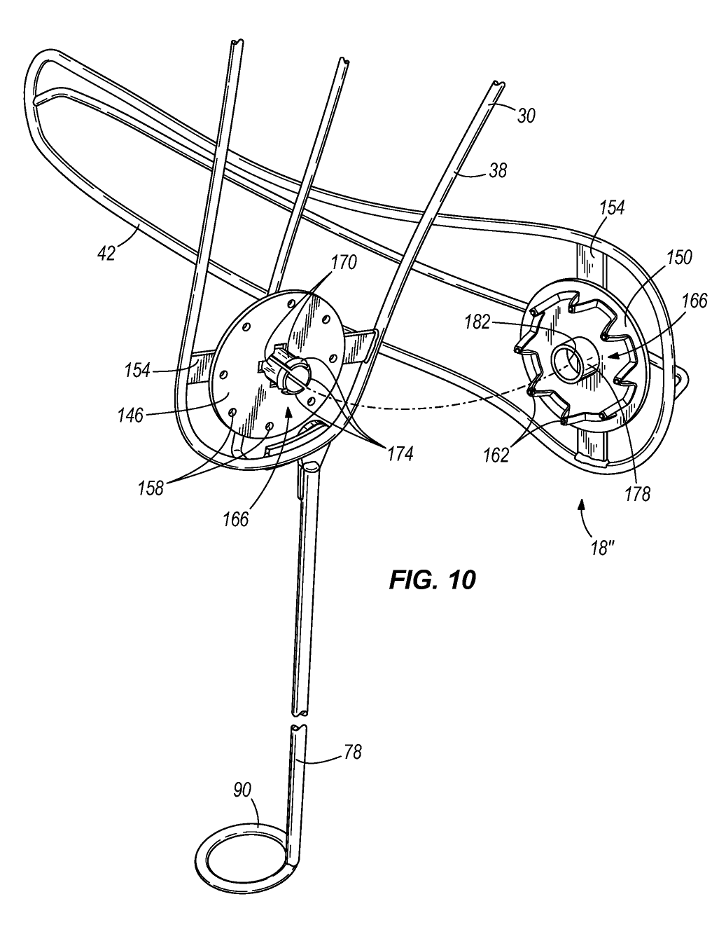

The fastener arrangement 54 includes a threaded member 66 (e.g., a threaded rod) and at least one nut 70. As illustrated in FIGS. 5 and 6, two wing nuts 70 are provided, however, as will be shown and described later with respect to FIGS. 7 and 8, a single nut 70 could be used. To adjust the joint 18 into any of the positions shown in FIG. 1, 2, 3, or 4, a user loosens the wing nuts 70 to relieve the clamping force on and between the plate elements 46, 50. The plate elements 46, 50, which directly engage one another in facing relationship, will then be free to rotate about the threaded member 66 relative to one another, thereby allowing the first and second members 38, 42 to be rotated or pivoted relative to one another about an axis of rotation defined by the threaded member 66. When the first and second members 38, 42 are positioned relative to one another in the desired rotational position, the user tightens the wing nuts 70 to create a clamping force on and between the plate elements 46, 50 that will securely hold the plate elements 46, 50 together and in their relative rotational orientation. The illustrated plate elements 46, 50 have generally smooth abutting surfaces 74 that will permit an unlimited number of relative rotational orientations. In other embodiments, the abutting surfaces 74 could be textured (e.g., with an abrasive or high-friction material) to increase the friction between one another. In yet other embodiments, ribs, stops, teeth, or other features (see e.g., FIGS. 9 and 10) could be added to the plate elements 46, 50 to provide a predetermined number of possible relative rotational orientations.

As best shown in FIGS. 2, 3, and 5, one or more legs 30 can include a support stand 78 coupled to one of the first or second members 38, 42 adjacent the adjustable joint 18. The support stand 78 is movable between a first position for supporting the deer 10 in one of the plurality of different stationary display configurations (see FIGS. 1, 2, and 3), and a second position that does not support the deer 10 (see FIG. 4). As shown in FIGS. 5 and 6, the support stand 78 is pivotally coupled to the first member 38 by a rivet or other projection 82 defining a pivot axis about which the support stand 78 can rotate. A stop 86 formed by a wire of the first member 38 can be provided to limit rotation of the support stand 78 in one direction. The support stand 78 can be of a similar metal wire material as the remainder of the wire-frame of the deer 10, and in the illustrated embodiment is formed into a circular end 90 for receiving a stake or other securing member (not shown) to secure the support stand 78 to the ground.

The support stand 78 is in the first position when the leg 30 is in the extended position for standing (see FIG. 1), and can be staked to the ground to support the deer 10 and prevent tipping. Alternatively, the stake can be secured to the bottom of the second member 42. When the leg 30 is configured in the prancing or leaping orientations shown in FIGS. 2 and 3, the support stand 78 is also in the first position and extends to the ground while the second member 42 is rotated so as to not touch the ground. In the display configurations of FIGS. 2 and 3, the stake can be secured to the circular end 90 of the support stand 78 to support the deer 10. When the leg 30 is configured in the kneeling orientation shown in FIG. 4, the support stand 78 can be rotated about its pivot projection 82 so that it can lie on the ground in a manner similar to the second member 42.

As shown in FIGS. 3 and 3a, when the deer 10 is configured for the leaping pose, a second support stand 94 can be coupled to the body 22 (i.e., a third member 22) to elevate the front of the deer 10 (i.e., the front of the body 22 and the front legs 30). The second support stand 94 can cooperate with the first support stand 78 to support the deer 10 since both front legs 30, and more specifically both second members 42, are elevated off the ground. As shown in FIG. 3a, the second support stand 94 can be formed of metal wire and can be received in a receiving member 98 coupled to the body 22. The receiving member 98 can take the form of sleeve coupled (e.g., welded) to a wire 102 that defines the body 22, and that can slidingly receive an end of the second support stand 94. A fastener arrangement 106 is coupled to the sleeve 98 to secure the second support stand 94 relative to the sleeve 98. As shown in FIG. 3a, a wing nut 110 fixed to a threaded rod 114 can be tightened or loosened such that the rod 114 enters or withdraws from the sleeve 98. When tightened, the rod 114 abuts the second support stand 94 to secure the stand 94 relative to the sleeve 98 (i.e., like a set screw). In other embodiments, other fastener arrangements and receiving members can be substituted. The second support stand is removable, and need only be used for the leaping pose shown in FIG. 3.

FIGS. 7 and 8 illustrate a second embodiment of an adjustable joint 18′. Like parts have been given like reference numbers and will not be discussed again in detail. A different fastener arrangement 54′ is used and includes a threaded member 122 (see FIG. 8) with a handle or knob 126 fixed to one end of the threaded member 122 such that rotation of the knob 126 causes rotation of the threaded member 122. Two nuts 130, 132 are provided to receive the threaded member 122 after it has passed through the apertures 52 of the plate elements 46, 50. The nut 130 can be non-rotatably secured to the second plate element 50 (e.g., by welding, adhesive, or other geometry that prevents relative rotation between the nut 130 and the second plate element 50). The second nut 132 can then be positioned on the threaded member 122 to abut the first nut 130. The user need then only turn the knob 126 to tighten and secure the two plate member 46, 50 relative to one another, or to loosen the plate members 46, 50.

FIGS. 9 and 10 illustrate a third embodiment of an adjustable joint 18″ Like parts have been given like reference numbers and will not be discussed again in detail. Different first and second plate elements 146, 150 are provided. Each plate element 146, 150 is secured to and supported on a wire support 154 formed with the wires of the first and second members 38, 42. Adhesives or fasteners can be used to secure the plate elements 146, 150 to the wire supports 154. The illustrated plate elements 146, 150 are plastic and are generally circular in shape, however, other materials and shapes can be used for the plate elements 146, 150. The first plate element 146 includes apertures or recesses 158 positioned circumferentially around the plate element 146. The second plate element 150 includes teeth or projections 162 spaced circumferentially about the second plate element 150 in the same pattern as the apertures 158, such that when the first and second plate elements 146, 150 are positioned in facing relationship, the projections 162 can be received in the apertures 158. The mating engagement of the projections 162 and apertures 158 provides a plurality of distinct, rotational orientations available between the first and second plate elements 146, 150, and therefore between the first and second members 38, 42.

The adjustable joint 18″ also has a different fastener arrangement 166 (see FIG. 10), that in the illustrated embodiment, is integrally formed with the plate elements 146, 150. The first plate element 146 includes a plurality (e.g., four are shown) of resilient fingers or tabs 170 extending from the planar body portion of the first plate element 146. Each tab 170 includes a locking member 174 at its distal end. The four tabs 170 extend from the central portion of the first plate element 146 and together define a generally cylindrical shaft. The second plate element 150 includes a central hub 178, which takes the form of a tubular, cylindrical extension from the center of the second plate element 150. The hub 178 operates as a tab-receiving portion that receives the tabs 170 therein. The inner diameter of the hub 178 can be slightly smaller than the outer diameter together defined by the four tabs 170 such that the tabs 170 will deflect inwardly upon insertion into the hub 178. With the projections 162 and apertures 158 aligned for the desired rotational orientation of the joint 18″, continued insertion of the tabs 170 into the hub 178 results in the locking members 174 eventually passing through a central aperture 182 in the second plate member 150. This allows the tabs 170 to return to their un-deflected state by moving radially outwardly. The locking members 174 engage the surface of the second plate element 150 opposite the surface from which the projections 162 extend to secure the two plate elements 146, 150 together. The engagement between the projections 162 and the apertures 158 provides a biasing force that biases the plate elements 146, 150 apart from one another, thereby enabling the locking members 174 to secure the plate elements 146, 150 together.

When a user desires to reconfigure the deer 10 by adjusting the joint 18″, he presses or squeezes the locking members 174 radially inwardly, thereby contracting the cylindrical shaft formed by the tabs 170 until the outer diameter of the tabs 170 and the locking members 174 is small enough to pass through the central aperture 182. This allows the tabs 170 to withdraw axially from the central hub 178, thereby separating the first and second plate elements 146, 150. Once the projections 162 are removed from the apertures 158, the plate elements 146, 150 and the corresponding first and second members 38, 42 can be rotated relative to one another to a different rotational orientation. Once the projections 162 are aligned with the apertures 158, the user can then press the plate elements 146, 150 together to insert the projections 162 into the apertures 158 while at the same time inserting the tabs 170 into the hub 178 until the locking members 174 pass through the central aperture 182 and snap radially outwardly into locked engagement with the second plate element 150.

It is to be understood that the illustrated projections 162 and apertures 158 can vary from the configurations shown in FIGS. 9 and 10. More or fewer projections 162 and apertures 158 could be provided. Additionally, other geometry, including intermeshing teeth or ribs could be used instead of the projections 162 and apertures 158. Additionally, the fastener arrangement 166 could also be varied. For example, fewer or more tabs 170 could be provided. In yet other embodiments, the fastener arrangements 54 and 54′ could be substituted for use with the plate elements 146, 150.

While the illustrated wire-frame deer 10 is shown having adjustable joints 18, 18′, or 18″ at the knee joints of the four legs 30, it is to be understood that additional adjustable joints 18, 18′, and 18″ could be added in other locations. For example, adjustable hip joints could be formed. Adjustable joints could also be provided between the body 22 and the neck 28, and between the neck 28 and the head 26 to allow for up and down or side-to-side adjustment between various stationary display configurations. An adjustable joint may also be positioned between the body 22 and the tail 186 such that the tail 186 can be raised up, or positioned in a back or down orientation. Furthermore, while the illustrated joints 18, 18′, and 18″ provide adjustment along a single axis of rotation, additional joints 18, 18′, and 18″ could be combined to provide adjustability between two members about multiple axes of rotation.

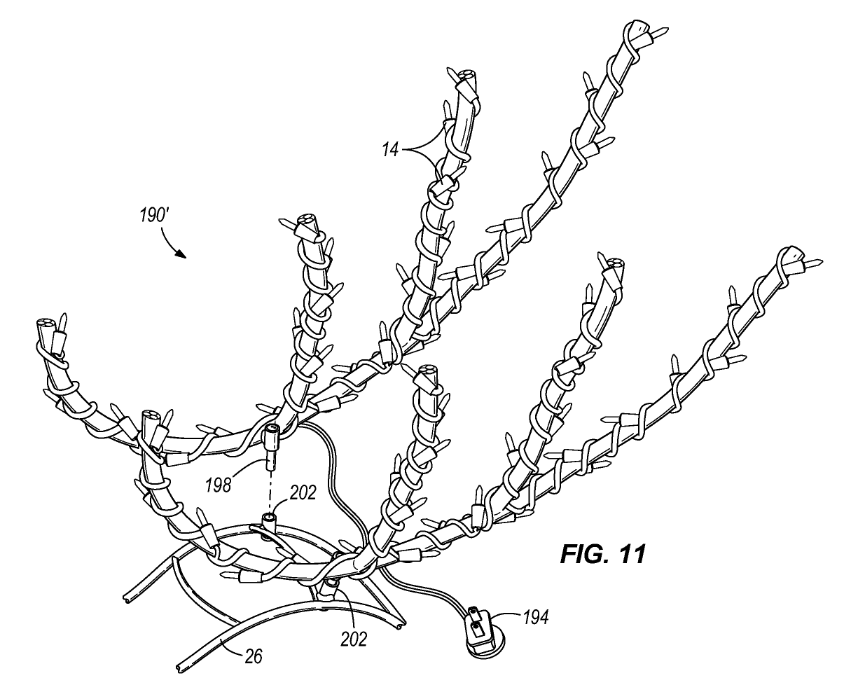

As shown in FIGS. 1, 2, 3, and 4, the wire-frame deer 10 further includes removable antlers 190 without light elements 14. FIG. 11 illustrates a different set of removable antlers 190′ with quick-connect electrical fittings 194 (e.g., sockets or plugs) for the light elements 14 on the antlers 190′. A user or retailer can choose which antlers 190, 190′, if any, to mount on the deer 10. Antlers 190, 190′ can be customized by providing a variety different antler inserts. If a buck form is desired, a particular antler form (e.g., an accessory member) can be selected, installed, and then the light elements 14 can be quickly connected by plugging the quick-connect electrical fitting 194 (see FIG. 11) into a mating plug/socket on the head 26 (e.g., base member) of the deer 10. If a doe form is desired, no antlers need be added. The antlers 190, 190′ can include one or more mounting projections 198 (see FIG. 11) sized and configured to be received in mating receiving portions 202 on the head 26.

Additionally, and while not shown, different tail inserts can be provided with quick-connect electrical fittings (e.g., standard male or female connector plugs, or other similar fittings) for the light elements 14 such that a particular tail (e.g., an accessory member) can be selected, installed, and then the light elements 14 can be quickly connected by plugging the quick-connect electrical fitting into a mating plug/socket on the body 22 (e.g., the base member) of the deer 10.

One skilled in the art will understand that with the different inserts or accessory members described above, the wire-frame form 10 can be made modular and customizable with standard structural connections for the wire-frame form 10 and standard electrical connections for the light elements 14. Additionally, should the light elements 14 fail on one accessory, a replacement accessory can be purchased or used without the need for replacing the entire base wire-frame form 10. Furthermore, the use of adjustable joints 18, 18′, and 18″ makes the wire-frame form 10 further customizable, and allows a single base form 10 to be selectively re-configured to any number of desired stationary display configurations or poses. These product innovations will enable the retailer to provide customers all of the above-described style options (and more) with only one modular, re-configurable base wire-frame form 10 instead of multiple different base wire-frame forms. Modular options or accessories (e.g., antlers and tails) can be sold separately on an individual basis or can be sold all together as a customizing kit to provide further reconfiguration options.

As mentioned above, the adjustable joints 18, 18′, and 18″ and modular accessories can be used on other wire-frame forms (e.g., Santa, snowmen, elves, sleighs, moose, horses, and Halloween figures). For example, a Santa, a snowman, an elf, or a human-form Halloween figure might have adjustable joints 18, 18′, and 18″ at shoulders, elbows, wrists, and fingers to enable the user to select various poses for arms, hands, and fingers, such as down at the side of the body, on the belly, up in the air, waving, pointing, grasping an item, and the like. Adjustable joints 18, 18′, and 18″ can be positioned at any desired location on a wire-frame form to provide configuring options.

Likewise, any number of different accessory items can be provided depending on the particular wire-frame form. For example, a number of different accessory tools might be provided for elves. As another example, different hats, noses, eyes, and mouths could be provided for a snowman, a Halloween figure, or another human-like form. Different gift packages could be provided for use with a sleigh. These are just a few of the examples of interchangeability and modularity that can be achieved using accessories that can be selectively attached (both structurally and electrically) to a base wire-frame form.

Various features and advantages of the invention are set forth in the following claims.

What is claimed is:

1. A wire-frame form comprising:
a first member;
a second member coupled to the first member with an adjustable joint such that the first and second members can be positioned relative to one another in one of a plurality of different stationary display configurations; and
light elements positioned on each of the first and second members, the light elements being operable when the first and second members are in any one of the plurality of different stationary display configurations to illuminate the first and second members.

2. The wire-frame form of claim 1, wherein the first member takes the form of an upper leg of a deer and the second member takes the form of a lower leg of the deer.

3. The wire-frame form of claim 1, wherein the adjustable joint includes a first plate element on the first member, a second plate element on the second member, and a fastener arrangement releasably securing the first plate element relative to the second plate element.

4. The wire-frame form of claim 3, wherein the fastener arrangement includes a threaded member and at least one nut.

5. The wire-frame form of claim 4, wherein the nut is a wing nut.

6. The wire-frame form of claim 3, wherein the first and second plate elements directly engage one another.

7. The wire-frame form of claim 3, wherein the first plate element includes apertures and the second plate element includes projections, the projections being received in the apertures to releasably secure the first plate element relative to the second plate element.

8. The wire-frame form of claim 7, wherein the fastener arrangement includes a resilient tab on one of the first and second plate elements and a tab-receiving portion on the other of the first and second plate elements for receiving the resilient tab.

9. The wire-frame form of claim 1, further comprising a support stand coupled to one of the first and second members adjacent the adjustable joint, the support stand being movable between a first position for supporting the wire-frame form in one of the plurality of different stationary display configurations, and a second position that does not support the wire-frame form.

10. The wire-frame form of claim 9, wherein the support stand is pivotally coupled to the one of the first and second members.

11. The wire-frame form of claim 1, further comprising a third member connected to one of the first and second members, and a support stand removably connected to the third member to support the wire-frame form when the first and second members are positioned in one of the plurality of stationary display configurations.

12. The wire-frame form of claim 11, wherein the wire-frame form takes the form of a deer with the first member taking the form of an upper leg of the deer, the second member taking the form of a lower leg of the deer, and the third member taking the form of a body of the deer, the support stand removably connected to the body of the deer when the deer is configured in a leaping display configuration.

13. The wire-frame form of claim 1, further comprising an accessory member removably connected to the wire-frame form and having accessory light elements, the accessory member including a quick-connect fitting for electrically connecting the accessory light elements to the light elements.

14. A wire-frame form comprising:
a first member;
a second member coupled to the first member with an adjustable joint such that the first and second members can be positioned relative to one another in one of a plurality of different stationary display configurations;
a support stand coupled to one of the first and second members adjacent the adjustable joint, the support stand being movable between a first position for supporting the wire-frame form in one of the plurality of different stationary display configurations, and a second position that does not support the wire-frame form; and
light elements positioned on each of the first and second members, the light elements being operable when the first and second members are in any one of the plurality of different stationary display configurations to illuminate the first and second members.

15. An illuminated, wire-frame deer comprising:
a body;
a head coupled to the body;
four legs coupled to the body, each of the four legs having an adjustable joint enabling the leg to be configured into a plurality of fixed orientations such that the wire-frame deer can be selectively oriented into any one of a standing pose, a prancing pose, a leaping pose, and a kneeling pose; and
light elements on each of the body, the head, and the legs.

16. The illuminated, wire-frame deer of claim 15, further comprising a support stand pivotally coupled to one of the four legs adjacent the adjustable joint, the support stand being movable between a first position for supporting the wire-frame deer in the standing pose, the prancing pose, and the leaping pose, and a second position that does not support the wire-frame deer in the kneeling pose.

17. The illuminated, wire-frame deer of claim 16, wherein the support stand is a first support stand and further comprising a second support stand removably coupled to the body to support the wire-frame deer in the leaping pose.

18. The illuminated, wire-frame deer of claim 15, further comprising removable antlers configured to be selectively coupled to the head, the antlers including antler light elements and a quick-connect fitting for electrically connecting the antler light elements to the light elements on the head, the body, and the legs.

19. The illuminated, wire-frame deer of claim 15, wherein each adjustable joint is positioned to define a knee joint between an upper leg portion and a lower leg portion on the respective leg, each adjustable joint including a first plate element on the upper leg portion, a second plate element on the lower leg portion, and a fastener arrangement releasably securing the first plate element relative to the second plate element.

20. The illuminated, wire-frame deer of claim 19, wherein the first and second plate elements directly engage one another.

21. The illuminated, wire-frame deer of claim 19, wherein the first plate element includes apertures and the second plate element includes projections, the projections being received in the apertures to releasably secure the first plate element relative to the second plate element.
